(19) United States
(12) Patent Application Publication
(10) Pub. No.: US 2013/0346085 A1
(43) Pub. Date: Dec. 26, 2013

(54) MOUTH CLICK SOUND BASED COMPUTER-HUMAN INTERACTION METHOD, SYSTEM AND APPARATUS

(71) Applicant: Zoltan Stekkelpak, Sunnyvale, CA (US)

(72) Inventor: Zoltan Stekkelpak, Sunnyvale, CA (US)

(21) Appl. No.: 13/531,526

(22) Filed: Jun. 23, 2012

(51) Int. Cl. G10L 21/00

(52) U.S. Cl. 704/275; 704/E21.001

(57) ABSTRACT

Methods, systems, and apparatus, including computer programs encoded on a computer storage medium, and including hardware devices performing a mouth click sound based human-device interaction. In one aspect, receiving at least one mouth click sound signals from a human user, by an acoustic-to-electric sensor of a computing device, and processing the received signals. The received mouth click sound signals may be accompanied by other mouth click sound signals, and other interaction signals.

### FIELD OF THE DISCLOSURE

The present disclosure generally refers to Human-computer and Human-device Interaction, and more specifically it relates to a mouth click sound based device controlling system, method and apparatus.

### BACKGROUND

Human-computer Interaction (HCI) or, more generally, Human-device Interaction involves the design of the interaction between people and electric devices, including computers and mobile devices.

Trends in Human-device interaction indicate an improvement in user experience by providing various ways for the users to give input signals to an electric device in many possible situations. The optimal interaction method can depend on the situation (eg. working on a desk, or browsing the internet on a tablet device), on the availability of hardware and software tools (eg. microphone, camera, face recognition software), on limitations implied by the environment (eg. not being able to take a phone call during a meeting) and on subjective preferences of the user.

In certain situations, there is a need for hands-free control methods (eg. interacting with a mobile device when driving a vehicle), in other situations, it's more convenient for the user not to use their hands (eg. interacting with displays mounted on the head or on the eye of the user).

In some situations, there is a need for a combination of various control methods, whereby a command is provided to a device by two or more different input methods. For example, a user may give a command to an augmented reality device by a combination of voice and hand gestures, or a combination of eye gazing and voice, or a combination of eye gazing and hand gestures.

In other situations, human speech is given as an input to an electric device, combined with limiting or preferential factors described above. In such cases, there is a need for differentiating between speech as an input and other verbal signals as commands.

The above described reasons (amongst others) require from electric devices the utilization of verbal sounds generated by humans, that aren't usually pronounced or produced during a regular human speech.

### SUMMARY

One or more implementations are explained below, and in the drawings attached. Other implementations will be apparent from the description, from the attached drawings and the claims.

In one general aspect, a method and apparatus is provided for improving the user experience and the accuracy of the signals given during Human-computer Interaction or more broadly, Human-device Interaction. This method or apparatus comprises of one or more mouth click sounds produced by a human user.

As described later in this document, the mouth click sounds used in this invention aren't typically pronounced during a normal verbal communication between humans, and they are distinct from the pronunciation of any sounds and letters in the English alphabet.

In one general aspect, the mouth click sounds are interpreted as a single user intent signal. On some implementations described below, the mouth click sounds may be accompanied by other user interaction signals to form a user intent given to a computing device. Such other user interaction signals may include amongst others eye gazing signals, hand motion signals, head motion signals, verbal signals.

The invented mouth click sound based computer-human interaction method and apparatus can be performed in relation to various hardware elements and device implementations, including head mounted augmented reality devices, laptop and desktop devices, and portable devices (such as tablets and smartphones).

The invention improves the user experience in Human-computer Interaction and Human-device Interaction in several ways, including providing an additional signal source for use cases where the available set of interaction methods is limited (for example due to environmental factors).

### BRIEF DESCRIPTION OF THE DRAWINGS

Several aspects are set forth in the drawings. Other aspects will be apparent from the description.

In some cases, well-known functions, structures and components are shown in block diagram form in order to avoid obscuring the concepts of the subject matter.

FIG. 1 is a diagram that illustrates an example of the process with its main parts and functions according to an implementation.

FIG. 2 illustrates an example of the process of producing a mouth click sound according to an implementation.

FIG. 3 illustrates an example of the process of producing a mouth click sound according to a second implementation.

FIG. 4 illustrates an example process of a device processing the signals supported by a natural language and mouth sound training module, according to an implementation.

FIG. 5 illustrates an example of the process of processing a mouth click sound signal accompanied by other signals according to an implementation.

FIG. 6 illustrates an example of the process of processing a mouth click sound signal accompanied by eye gazing signals according to a head mounted device implementation.

FIG. 7 illustrates an example of a head mounted device including a display and an acoustic-to-electric sensor, according to an implementation.

FIG. 8 illustrates an example of a portable device including an acoustic-to-electric sensor, according to an implementation.

FIG. 9 illustrates an example of a desktop device including a display, an eye tracking sensor and an acoustic-to-electric sensor, according to an implementation.

FIG. 10 illustrates an example of laptop device including an eye tracking sensor and an acoustic-to-electric sensor, according to an implementation.

FIG. 11 illustrates an example of head phone device including an acoustic-to-electric sensor, according to an implementation.

FIG. 12 illustrates an example of the process of processing a mouth click sound signal provided as a response to a prompt signal according to an implementation.

### DETAILED DESCRIPTION OF THE INVENTION

The detailed description section below is intended to provide a description of various configurations, aspects and implementations of the subject matter, and is not intended to represent the only configurations, aspects or implementations in which the subject matter may be practiced. The attached drawings are incorporated herein and constitute a part of the detailed description. The detailed description includes specific details for the purpose of providing a thorough understanding of the subject matter. However, the subject matter is not limited to the specific details set forth herein and may be practiced without these specific details.

In some cases, well-known functions, structures and components are mentioned in a generic form in order to avoid obscuring the concepts of the subject matter.

This disclosure may be embodied as a method, system, hardware or computer program. This disclosure may take the form of an entirely hardware embodiment, an entirely software embodiment (including but not limited to firmware, resident software, micro-code, cloud based software) or an embodiment combining software and hardware aspects that may all generally be referred to in this document as a “module” or “system”. Furthermore, the subject matter in the present disclosure may take the form of a computer program product on a computer-usable storage medium having computer-usable program code embodied in the medium.

Features, parts, functions and components may be referred to in this document in both plural and singular forms, and they can be referred to associated with other terms, for example unit, set or module. Unless specified, the numbers and units formally represented by these references are irrelevant from the perspective of the subject matter. In other words, the subject matter may consist or may be practiced with one or more instances of the described feature, part, function or component, no matter how these features, parts, functions or components are organized into sets or units.

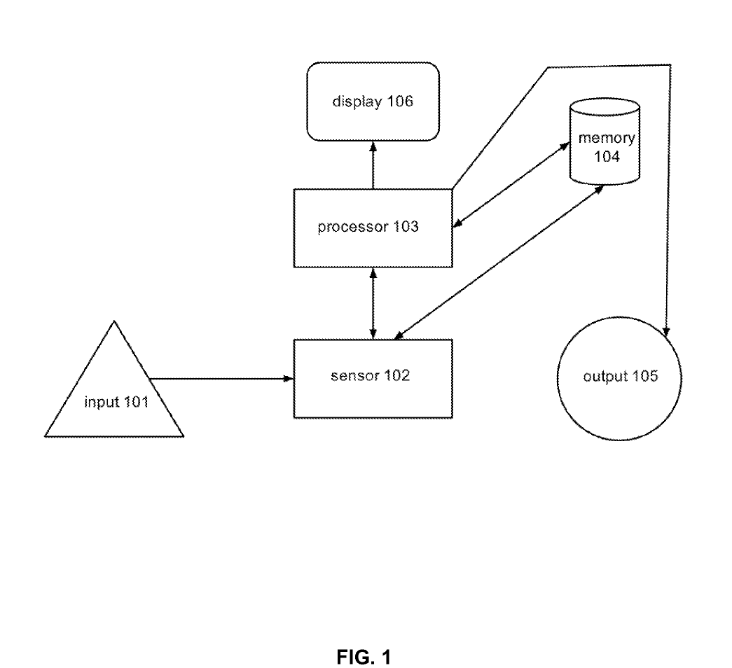

According to an implementation illustrated in FIG. 1, an input signal 101 is given to a sensor 102. The input signal 101 is processed by a processor 103. The sensor 102 and the processor 103 can avail of the capacities of a memory unit 104. The processor 103 produces output 105. The output may be displayed on display 106.

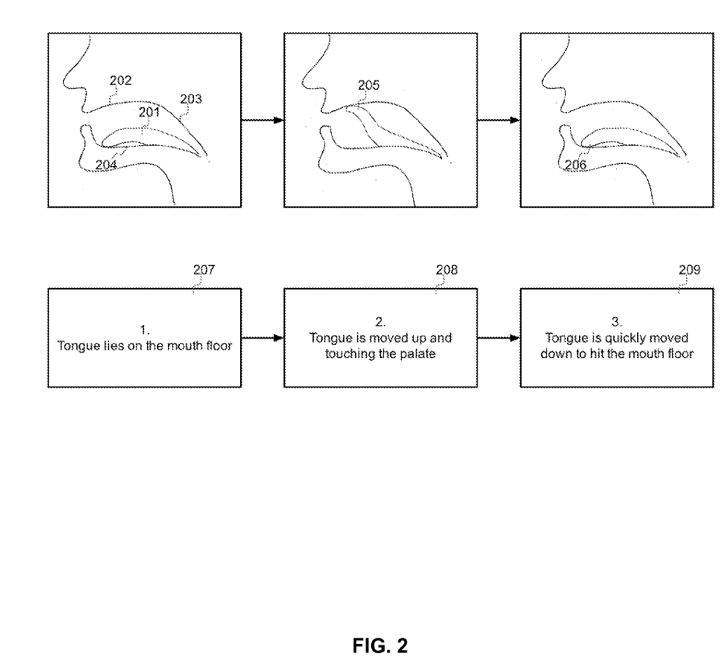

The popping sound, referred to as “mouth click sound” throughout this document, may be articulated by a human by pressing the tongue to the palate, then quickly removing the tongue from the palate. A mouth click sound may also be formulated by using one or more parts of the tongue, comprising any of the tongue base, the middle part of the tongue and the tip of the tongue. In other words, the mouth click may sound, in some but not all aspects, similar to the sound “K”, with the difference that by executing the mouth click sound, the tongue is touching the hard or soft palate, or both. FIG. 2 illustrates an example of producing the mouth click sound by a human via a series of three drawings and a three-step diagram accordingly. According to the drawing on FIG. 2, a mouth click sound is produced by the tongue 201, hard palate 202 and soft palate 203. First, the tongue 201 is moved up from the mouth floor 204 to the hard palate 202 and/or the soft palate 203. Most commonly, the tip 205 of the tongue will touch the hard palate 202. Although not illustrated in the drawings, the middle part of the tongue may also touch the hard 202 or soft palate 203, or both. The mouth click sound is produced when the tongue hits 206 the mouth floor when moved down from the palate. In other words, as a first step, the tongue lies on the mouth floor (207). Then, the tongue is moved up and the tongue is touching the palate (208). The mouth click sound is produced when the tongue is quickly moved down from the palate so that it hits the mouth floor (209). According to one alternative of this process, step 207 is optional.

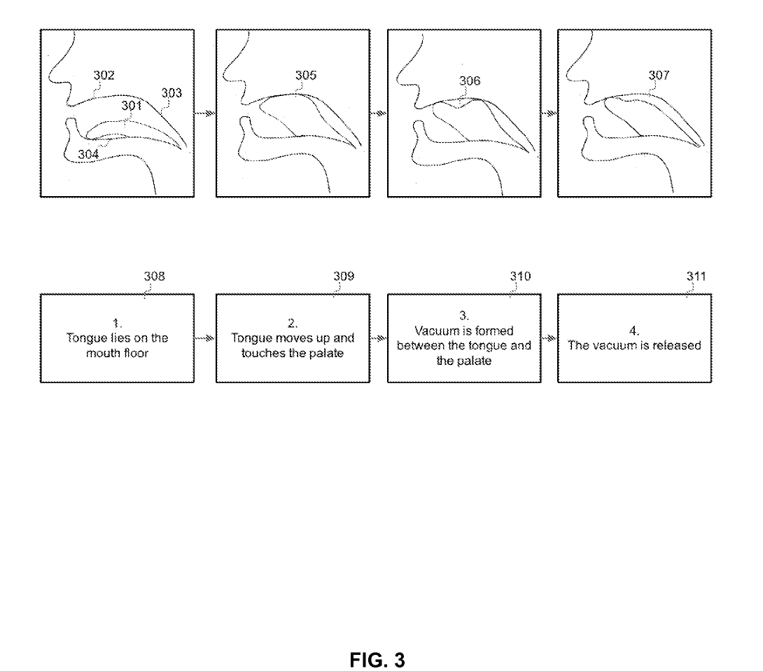

Additionally and/or alternatively, according to FIG. 3, a mouth click sound may also be produced by a human by moving the tongue 301 from the mouth floor 304 to the hard palate 302 and/or the soft palate 303, so that the tongue touches 305 the palate. Then a vacuum 306 is created by removing the middle part of the tongue from the palate. The mouth click sound is produced when the vacuum 306 is released 307 from between the tongue and the palate, for example, by removing part of the tongue from the palate. In other words, the process is explained in the following process: the tongue lies on the mouth floor (308), then the tongue is moved up to the palate (309), then vacuum is formed between the tongue and the palate (310), and finally the vacuum is released (311). According to one alternative of this process, steps 308 and 309 are optional.

Although not illustrated in the exemplary drawings, all and any of the aforementioned methods may be executed with both open and closed lips.

The mouth click sound described in this specification is not intended to cover sounds produced by humans in a general, human-to-human speech in the English language. In other words, the mouth click sounds used in the subject technology are not commonly used pronunciations of any letters of the English alphabet. In some but not all aspects, the mouth click sound may sound similar to the natural pronunciation of the letters “K” or “L”, however, this document is not intended to cover the natural pronunciations of the letters “K” or “L” of the English alphabet.

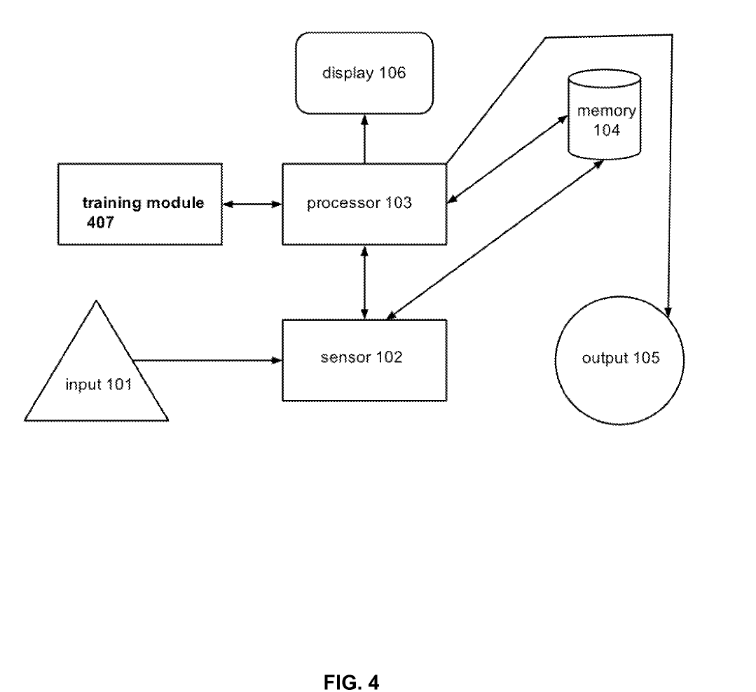

In order to be capable of making a distinction between a human's natural speech, other mouth sounds (including coughs, throat sounds) and the mouth click sound, as illustrated in FIG. 4, the subject technology may be provided with an acoustic signal recognition training module 407, which may include any combination of a speech recognition, a mouth click sound recognition, a pattern recognition, and machine learning submodules. One benefit of this training module is to provide the hardware device or the software application capacities of the distinction between the sounds that are commonly part of a natural human speech, and the mouth click sounds used to provide commands to the device or program. This training module, in some implementations, may be operated in a user-specific way, whereby the training module builds the distinction capabilities based on a single user's individual speech and mouth click sound characters. In other implementations, this training module is provided in a way which allows building training data and machine learning models based on multiple users' learning sample input. The training model could be, in some implementations, provided in a form which allows an initial set-up of the subject technology on a hardware device or in a software application. In other implementations, the training module could have a continuous mode, whereby the training data are provided by the user(s) during real-life usage sessions. The training data provided to the training modules could contain samples of one or more users' speeches, pronunciation, spoken sentences as well as samples of the mouth click sounds provided by the user(s). One specific benefit of the training module is to provide the subject technology a capability to make distinctions between a mouth click sound and the natural pronunciation of the letters “K” and “L” of the English alphabet.

In one implementation, the subject matter is utilized accompanied with one or more hardware devices. The subject technology's operation could be supported by one or more central processing units, one or more memory units, one or more display units, and one or more acoustic-to-electric sensors. The acoustic-to-electric sensor can perform its function in such a way that the said sensor is built into the main unit of the hardware device. In other embodiments, the acoustic-to-electric sensor may reside outside of the main unit of the hardware device. In such implementations, the communication between the main unit of the hardware device and the said sensor can be performed via electric wire(s) or wireless ways. In one embodiment, the acoustic-to-electric sensor is a microphone, which translates acoustic signals received from the user or from the environment into electric signals, interpretable by software or hardware methods. The acoustic-to-electric sensor is provided to capture the mouth click sound produced by the user in an interaction with a software or hardware device. The acoustic-to-electric sensor then converts the captured mouth click sound signal(s) into electric signals interpretable by the accompanied hardware or software. The mouth click sounds may be produced by a human user in such a way that the sound is only audible in a close proximity to the user. However, the mouth click sounds may not be audible, even in close proximity, to a human. In such cases, an acoustic-to-electric sensor is provided to detect the mouth click sound(s) such that the electric-to-acoustic sensor resides in a hardware device attached to the user's head. In other implementations, the acoustic-to-electric sensor may be physically separated from the main hardware unit.

In one but not all use cases, the user provides verbal commands to a hardware device, or to a software application. These commands can be communicated by the user to the hardware device or to the software application in forms of mouth click sounds. A mouth click sound may be interpreted by the hardware device or software application as an intent to perform a task or a function. For example, by producing one or more mouth click sounds, the user can give various commands to the hardware device or software application, including but not limited to: turning on, turning off, stopping running functions, cancelling previously given commands, cancelling processes automatically initiated by the device or program, providing a confirmation to a prompt, making an object selection, or creating or deleting an object. For example, the following message is presented to the user on a graphical user interface: “Do you really want to delete the selected image?” By producing the mouth click sound, the user provides the intent “yes” to the question. In another example, multiple objects are presented to the user on the display of a device (eg. computer, mobile phone or augmented reality device). The user then submits its selection over an object by providing a mouth click sound when the object is selected. In yet another example, the user dictates an e-mail to a mobile phone or an augmented reality device. In this case, it would be disadvantageous to give the “send” command to the device by saying the word “send”, since the device may not be capable of deciding whether the user said “send” as part of the dictated text for the e-mail, or as a command to submit (send) the previously dictated text. In this case, the mouth click sound could provide the “send” intent to the device or software application.

In various user interaction situations, there may be a need of differentiating between multiple intents communicated by the user by producing mouth click sounds. This and similar needs are satisfied with a feature, which allows the user to provide repeated mouth click sounds in a sequence. For example, by producing two mouth click sounds in one sequence (eg. with a 500 milliseconds delay between the first and the second click sounds), the user can provide the intent “Cancel” to an augmented reality device, while one mouth click sound would mean “Yes”. In another example, an augmented reality device user can select an object on a display with a first, single mouth click sounds, and provide action commands to the device pertaining the selected object with a second signal of two, repeated mouth click sounds in a sequence.

The signal made of two, repeated mouth click sounds in a sequence relies on a time delay between the two consecutive mouth click sounds. This time delay, in one implementation, could be between 0.5 milliseconds and 3000 milliseconds. The exact time delay between the two consecutive mouth click sounds could, in one implementation, be specified by the user. In such implementations, the user, on a graphical user interface, selects the preferred time delay between the two consecutive mouth click sounds. In other implementation, the user can provide training data (eg. repeated mouth click sound samples) to the system, which, in return, sets the time delay between the two consecutive mouth click sounds automatically, based on the provided training data.

In an implementation where the subject matter can be provided both the single, and the repeating mouth click sounds, the system considers two mouth click signals given by a user as two individual mouth click sound signals (as opposed to the one signal made of two, consecutive mouth click sounds), if the time delay between the two mouth click sounds is above the set time delay, be it set by the user or automatically by the system (based on the training data).

The subject matter may be utilized in, for or accompanied to various hardware devices, including but not limited to: desktop computers, laptop computers, tablet devices, mobile devices (eg. smartphones), augmented reality devices. The subject matter may also be used in combination with head, eye or arm mounted portable devices.

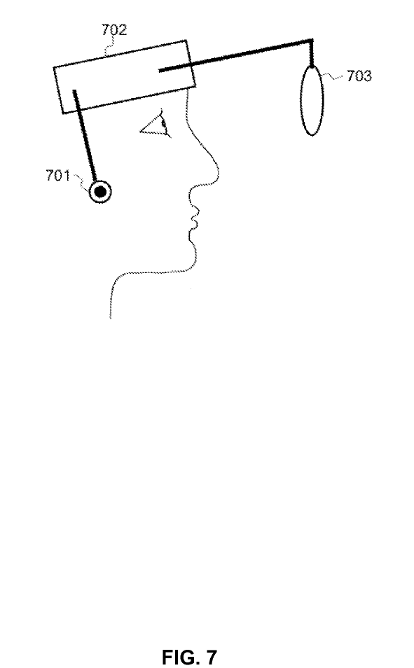

In one implementation, the subject matter may be utilized in combination with a head mounted augmented reality device. The augmented reality device could, amongst others, resemble a smart pair of glasses, a smart computational sensoric and display device mounted on a frame of glasses, a helmet, or a hardware piece mounted to various parts of the head of a human user, including but not limited to the one or both eyes of the user. In one particular implementation, the augmented reality device could be a hardware feature set mounted to a human user's regular glasses or sunglasses. In any of these implementations, the acoustic-to-electric sensor may be built into the main hardware unit of the augmented reality device, or it may be physically separated from it. FIG. 7 schematically illustrates an augmented reality device implementation. In this implementation, the mouth click sound signal is captured by an acoustic-to-electric sensor 701 and provided to the computing device 702. The device is also equipped with a display 703.

The implementation of the subject matter in the combination with head mounted augmented reality devices is particularly practical. One of the several reasons for this practicality is the proximity of the acoustic-to-electric sensor to the user's mouth, where the mouth click sounds are produced. Because of the close proximity between the user's mouth and the acoustic-to-electric sensor, the sensor is capable of receiving weaker mouth click sound signals, which, for example, are not audible to other humans around the augmented reality device user. On reason for the acoustic-to-electric sensor for being able to accept weak mouth click sounds is the fact that the sounds are transferred from the user's mouth, palate and tongue to the sensor by the user's tissues, including the user's skull and the skin.

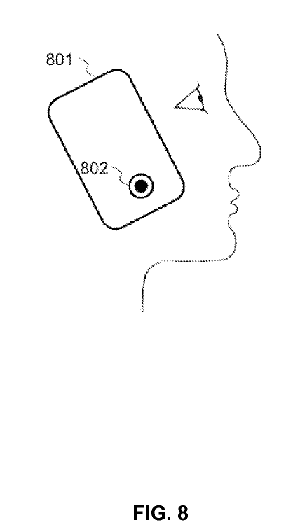

In other implementation (as illustrated in FIG. 8), the subject technology may be operated by a mobile device 801 (including but not limited to smartphones or tablets). In these implementations, the acoustic-to-electric sensor's 802 function could be performed by a built-in microphone of the mobile device, but it could also be performed by another sensor built into, or connected to the main hardware unit of the mobile device. In an exemplary use case, a user could, in a phone call session, provide the “hang up” intent by producing the mouth click sound.

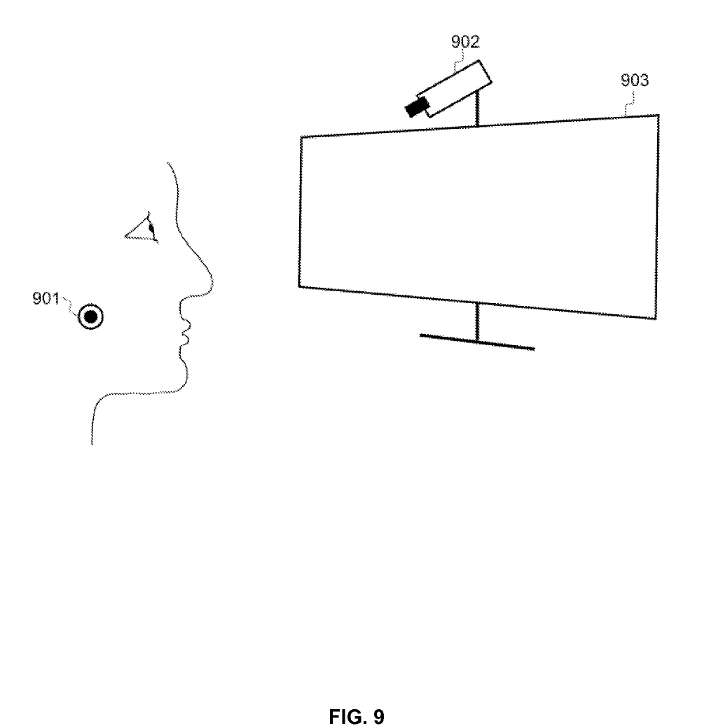

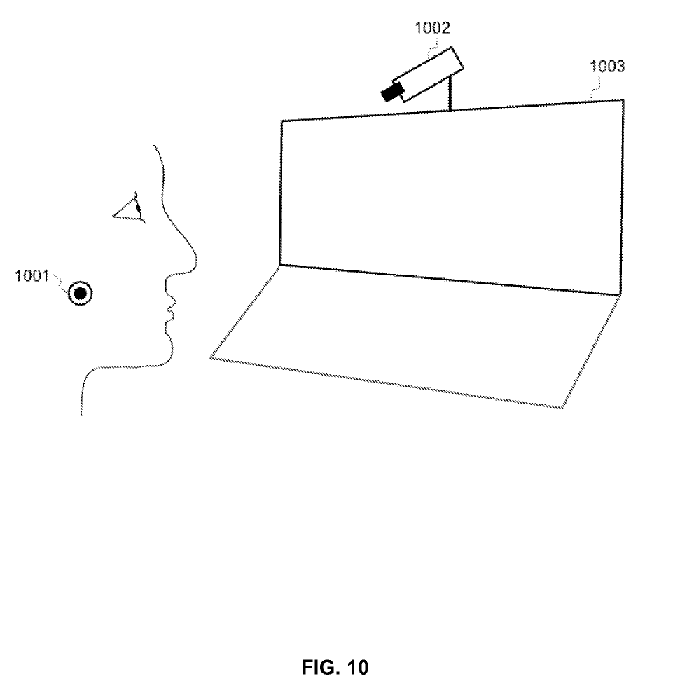

The subject technology could also be implemented in, on or accompanied to laptop and desktop computers. One of the several advantages of such implementation is that the user will be enabled to provide a richer set of commands within a human-computer interaction to the computer. One example (according to FIG. 9) is a desktop computer 903 equipped with a camera 902 capable of tracking the user's eye gazing signals (sometimes referred to as eye motion sensor or eye tracking device) and at least one acoustic-to-electric sensor 901, and associating those signals to object(s) displayed to the user on the computer's screen. The said object, utilizing the subject matter, can be manipulated by a combination of eye gazing signals and mouth click sounds in such a way that signals provided by the user by using the user's hand(s) are not required. One specific advantage of such and similar implementation is appreciated by disabled users, who are not capable of, or challenged by providing signals to the device using their hands. Another example (according to FIG. 10) is a laptop computer 1003 equipped with a camera 1002 capable of tracking the user's eye gazing signals and at least one acoustic-to-electric sensor 1001, and associating those signals to object(s) displayed to the user on the computer's screen.

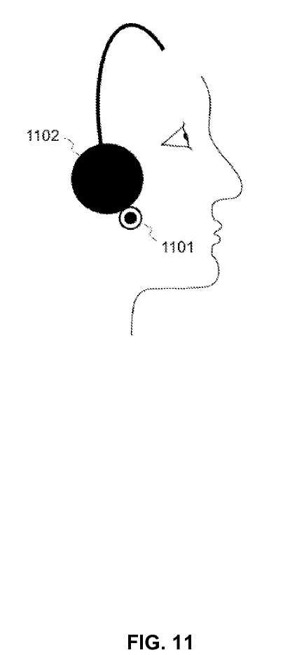

According to another implementation (as visually explained in FIG. 11), the acoustic-to-electric sensor 1101 is provided in such a way that it's physically connected to a headphone 1102. One of the several reasons for this practicality is the proximity of the acoustic-to-electric sensor to the user's mouth, where the mouth click sounds are produced. Because of the close proximity between the user's mouth and the acoustic-to-electric sensor, the sensor is capable of receiving weaker mouth click sound signals, which, for example, are not audible to other humans around the user.

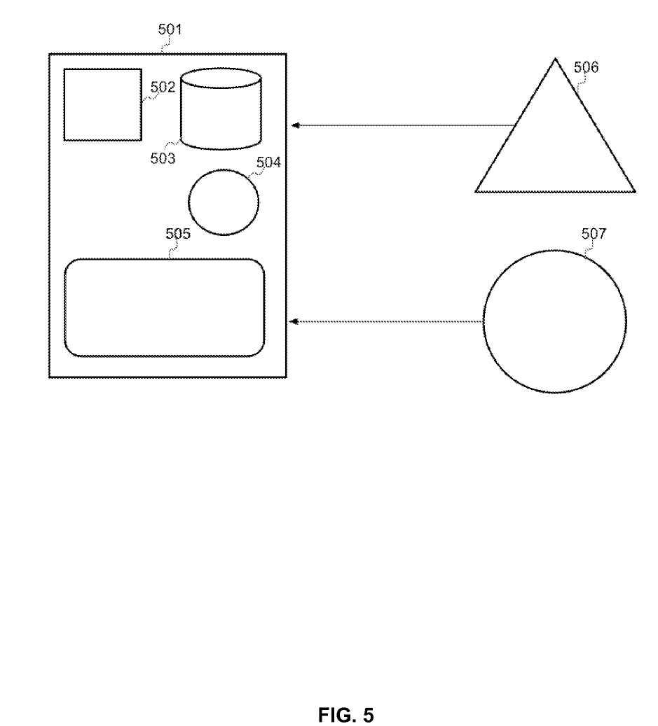

From a Human-Device Interaction (HDI) aspect, the subject matter can be utilized in a combination of other user interaction signals. An example of such an implementation is illustrated in FIG. 5. Those other signals may depend on, for example, the availability of various sensors and hardware elements (eg. input peripheries) in or attached to a device, or, those other signals may also depend on the situation in which the actual device is being used (eg. in a car, on a desktop, while walking etc). Furthermore, the HDI signals received by the device from a human user can also be depend on or limited by environmental circumstances (eg. noise, darkness). Various implementations of the subject matter, pertaining the combined utilization of one or more mouth click sounds and other HDI signals are set forth below. According to FIG. 5, in one embodiment, the device 501 comprises of at least one processor 502, at least one memory 503, at least one acoustic-to-electric sensor 504 and at least zero display 505. The mouth click sound signal 506, as an input it provided to the device. The interpretation or the processing of the mouth click sound signal 506 is dependent on other input signals 507 received by the device. The other input signals 507 may be eye motion signals, eye gazing signals, head motion signals, hand motion signals, finger motion signals, signals received from a touchpad, voice actions, speech signals or any combination of these signals. In the various implementations a sensor capable of receiving the mentioned signals is provided to the device. Several exemplary implementations are described below.

In the following embodiment an eye tracking device, a display and an acoustic-to-electric sensor is provided. In this embodiment, the user can select an object on the display by first gazing at one object, and then providing a mouth click signal to indicate to the system to select the object which is being looked at when the mouth click signal is given. For example, the display shows two objects. The user can gaze only at one object at once, which gazing is captured by the eye tracking device. The system considers the one object out of the two selected, which was being gazed at when the mouth click sound was produced by the user.

In the following embodiment an head mounted device is provided, including a head motion sensor, a display and an acoustic-to-electric sensor. In this embodiment, the user can select an object on the display by turning the head to the right, to the left, up or down, which movements move the selection from one object on the display to another object on the same display. Then the user provides a mouth click signal to indicate to the system to apply action onto the object which is being selected when the mouth click signal is given. For example, the display shows two objects. The user can move the selection from one object to the other, and only one of the objects can be selected at a time. The system applies an action (eg. opening, deleting, submitting, sending, posting to social streams) the one object out of the two to, which was being selected when the mouth click sound was produced by the user.

Augmented reality devices, as well as eye or head mounted devices can be equipped with one or more sensoric units, including but not limited to acoustic-to-electric sensor, microphone, accelerometer, light sensor, camera, proximity sensor, motion sensor, compass, geographical position detector, optical sensor, ambient light sensor, eye tracking sensor, eye gaze sensor. The signals captured by these sensors can be combined with one or more mouth click sounds, including the single mouth click sound and the repeated mouth click sounds, as well as the combination of these, to achieve an action, or to provide a command.

In one implementation, one or more eye gaze sensor is provided. The eye gaze sensor captures data pertaining the user's eye motion, which enables the device, for example, to identify one or more objects on which the user is focusing on, on a display or in the real world. The said eye glaze sensor is also capable of dynamically capturing a continuous flow of the user's eye gaze data. By providing eye gaze signals, a user can provide various intents to a device. For example, the user can make a first object selection on a display attached to the device. The object can be, for example, one or more of the following: text string, a graphical interface element (including, but not limited to buttons, checkboxes, radio buttons, links), an image, an icon, a graphical or textual representation of a file. After the first object selection is made, a second signal may be given by the user in form of one or more mouth click sounds, including the single mouth click sound and the repeated mouth click sounds, as well as the combination of these, to indicate an intent pertaining to the selected object. The intent indicated by this second signal could be, for example, deletion, confirmation, submission, sending, sharing, receiving, acceptance, start, stop, resume, quit.

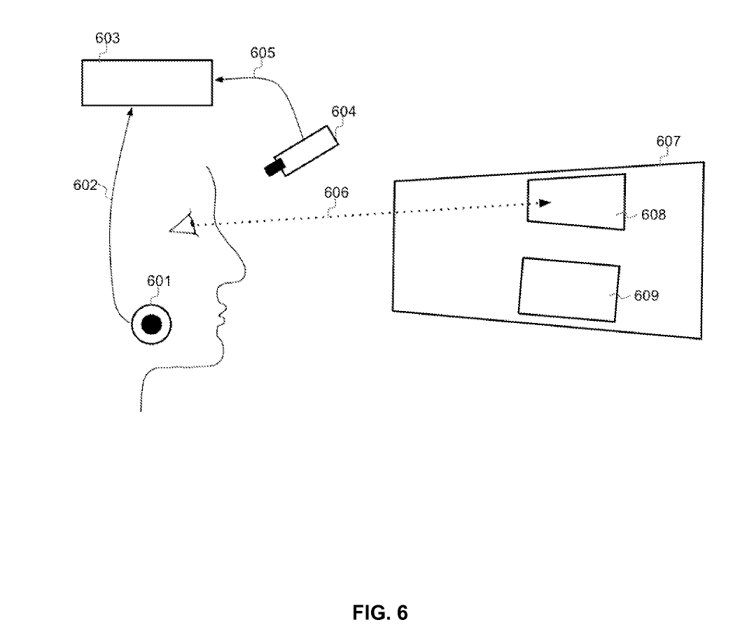

According to an example illustrated in FIG. 6, an acoustic-to-electric sensor 601, a computing device 603, an eye gaze sensor (sometimes referred to as eye tracking sensor) 604 and a display 607 is provided. In the exemplary drawing on FIG. 6, two objects 608 and 609 are displayed on the screen 607. The eye gaze sensor 604 receives a first signal of the user's eye motion 606 and forwards 605 it to the computing device 603. This first signal is indicative of the user looking at the object 608. Then a second signal is provided by the user in the form of a mouth click sound. This mouth click sound is detected by the acoustic-to-electric sensor 601, which forwards 602 the signal to the computing device 603. Based on this exemplary process described in FIG. 6, the computing device 603 will be enabled by the received signals to decide that the user intended to select the object 608 and not the object 609. In this process, the mouth click sound signal is given by the user to indicate the moment in which the user looks at the desired object.

In one example, the user could select a file by gazing at the file's icon, and open it by providing one or more mouth click sounds.

In a second example, the user could select a file by gazing at the file's icon, and delete it by providing one or more mouth click sounds.

In a third example, the user could select a file by gazing at the file's icon, and send it by providing one or more mouth click sounds.

In a fourth example, the user could select an object (an image, a video, a text) and share it on a social network by providing one or more mouth click sounds.

In a fifth example, the user could react on an incoming communication (for example a text message, a chat, a phone call, a video phone call, a sharing request) by gazing at the communication's prompt, and accepting it by providing one mouth click sound signal. Furthermore, the same communications prompt could be rejected by the user by providing two consecutive mouth click signals.

In a sixth example, the user could select a program or application icon on a display by gazing at the icon, and launch the associated program or application by providing one or more mouth click sounds.

In a seventh example, the user could select a video, and start playing or stop playing the video by providing one or more mouth click sounds.

In an eighth example, the user could select a running program or application and exit the said program or application by providing one or more mouth click sounds.

In a ninth example, an augmented reality device is provided, said device being equipped by a camera, in addition to the said head motion sensor(s). In this case, the user could select a physical object or a view of one or more physical objects by gazing at the said object(s) and capture a digital photograph or video of said object(s) by providing one or more mouth click sounds. In this exemplary use case, the subject matter is especially practical and appreciated by, for example, photographers, since it enables the users, for example, to capture images and videos in a hands-free way.

In a tenth example, an augmented reality device is provided, said device being equipped by a camera, in addition to the said head motion sensor(s). In this case, the user could select one or more physical objects by gazing at the said object(s) and request information of the selected object(s) by providing one or more mouth click sounds. In a more specific example, a user, wearing a head mounted augmented reality device, could gaze at the Eiffel tower, and requesting information about it. This and similar implementations could rely on and improve the utility of existing image recognition and image search technologies, including Google Image search or Google Goggles.

In another embodiment, an augmented reality device is provided, the said device being equipped with a sensor receiving signals about the head's motion(s). The sensor could be an accelerometer or any other motion detector sensor. The sensor receives signals indicating one or more head motion gestures (including moving the head up, down, to the right or to the left, or in directions in between). By providing any number or any combination of the head motion gestures, the user can provide various intents to the device, including object selection, zooming in, zooming out, flicking, paging, scrolling up, scrolling down, scrolling right and scrolling left. The object can be real world object or an object presented on a display attached to the device.

In an exemplary use case, the user can browse across multiple functionalities (eg. application launch icons for sharing on social media, taking a picture, capturing a video, checking e-mails) by providing head gesture signals to the device. By providing said head gesture, the focus is moved from one application's launch icon to another application's launch icon. For example, the launch icons of various applications on an augmented reality device may be presented in a grid on the device's home screen. In a more specific example, nine applications' launch icons could be presented in a form of a grid made of three horizontal rows, each horizontal row containing three applications' launch icons. By providing up, down, right or left head motion gestures, the user can move the focus across these nine icons. Once the focus is set on the desired application's launch icon, the user can provide the launch command by producing one or more mouth click sounds. In another implementation, the application launch icons could be organized into a single vertical line on the device's home screen, where the user can move the focus by providing up and down head motion gestures. In yet other implementations, the application launch icons could be organized into a single horizontal line on the device's home screen, where the user can move the focus by providing right and left head motion gestures. In a more advanced implementation, the application launch icons could be organized in a 3-dimensional grid, where the icons are organized along the x (horizontal) axis, the y (vertical) axis and the z (depth) axis. In such implementations, the focus can be moved along the x axis by providing horizontal head motion signals, along the y axis by proving vertical head motion signals, and along the z axis by providing front and back head motion signals. Once the focus is set on one of the application launch icons within the 3-dimensional grid, the launch command can be given by the user by producing one or more mouth click sound signals.

In another exemplary use case, a virtual album of digital images is provided, and displayed on the screen of a device. The images can be presented in one vertical (y axis) or horizontal (x axis) line, along a 2-dimensional grid (x and y axes), or along a 3-dimensional grid (x, y and z axes). By providing up or down (vertical), right or left (horizontal), front or back (depth) head motion gestures, the user can move the focus across the images in the album. Once the focus is set on the desired image, the user can provide various command by producing one or more mouth click sounds. The said command could be sending the selected image in an e-mail, sharing the selected image on social media, deleting the selected image, making multiple selection, enlarging the selected image.

In yet another implementation, a running application is provided, and presented to the user on the display of an augmented reality device. The said application could have one or more, vertical, horizontal, grid-like or 3-dimensional menu bars, each menu bar comprising of any number of options or features (for example, file operations, editing options, view options, help options). By providing horizontal head motion signals, the user could move the focus on a horizontal menu bar. By providing vertical head motion signals, the user could move the focus on a vertical menu bar. By providing a combination of horizontal and vertical head motion signals, the user could move the focus on a grid-like menu bar. By providing a combination of horizontal, vertical and front-back head motion signals, the user could move the focus on a 3-dimensional menu interface. Once the focus is set on the desired menu element (for example, Help), the user can provide various command by producing one or more mouth click sounds. By default, this command could be opening the selected menu element such that the options or features organized below said menu element will become visible to the user.

In yet another implementation, an augmented reality device is provided, the device being equipped with at least one camera and least one acoustic-to-electric sensor. An image recognition module is also provided, said module being capable of detecting and recognizing various hand or finger gestures, and the combination of hand or finger gestures and objects (for example objects visible on the display of the device, or physical objects being captured by the device's camera). In other words, a system is provided, which is capable of recognizing hand and finger gestures and objects on a static or dynamic image. In such implementations, the user can make a virtual object selection on the display of the device by pointing with the physical hands or fingers to any of the virtual objects in the user's field of vision. In other implementations, the user can make a physical object selection through the display of the device by pointing with the physical hands or fingers to any of the physical objects in the user's field of vision. Once the selection is made by the user (in other words, the focus is moved onto the desired physical or virtual object), a second signal can be provided by the user, said second signal comprising of one or more mouth click sounds. By providing this second signal, the user can provide various intents (for example, deleting, opening, sending in an e-mail, sharing on a social network, requesting information about, taking a digital photo or video of it, copying, pasting) to perform various tasks or actions pertaining the selected object(s).

In one exemplary use case of the above implementation, the user wearing an augmented reality device could point to the physical Eiffel Tower visible in the field of vision of the user. This pointing action causes the Eiffel Tower being selected. By providing one or more mouth click sounds, the user could send a request to a central server to provide information about the Eiffel Tower.

In another exemplary use case, the user could point to one CR-code (Quick Response code) with one ore more hands or fingers, and then by providing one or more mouth click sounds, the device could capture the information provided by the CR-code.

In implementations where the mouth click sounds are used in combination with hand or finger gestures, said hand or finger gestures can be any of pointing, waving, thumb-up, thumb-down, showing numbers, and any combination of these. Furthermore, the hand gestures could be provided with one hand or both hands of the user.

In yet another implementation, an augmented reality device is provided, the device being equipped with at least one touchpad and least one acoustic-to-electric sensor. The touchpad is capable of receiving one-dimensional (along one axis) and two-dimensional (along two axes) touch gestures applied to a surface. In such implementations, the user can make an object selection on the display of the device by providing a touch gesture on the touchpad to any of the objects in the user's field of vision. Once the selection is made by the user (in other words, the focus is moved onto the desired physical or virtual object), a second signal can be provided by the user, said second signal comprising of one or more mouth click sounds. By providing this second signal, the user can provide various intents (for example, deleting, opening, sending in an e-mail, sharing on a social network, requesting information about, taking a digital photo or video of it, copying, pasting) to perform various tasks or actions pertaining the selected object(s).

In yet another implementation, an augmented reality device is provided, the device being equipped with at least one acoustic-to-electric sensor. The augmented reality device is enabled to capture and interpret voice actions received from a user. A voice action could be, for example, “send an email to Joe”, “call Mary's cell phone number”, ‘schedule a meeting for tomorrow at 5 pm”, “search for a pizza place nearby”. In such implementation, the one or more mouth click sounds are used as a modifier signal. For example, by producing one or more mouth click sounds, the user indicates to a device, that a voice command will follow. This way the device can differentiate between normal human-to-human talk audible to the device, and a voice command given by a human user directly to the device. In another example, the user indicates the beginning and the end of a voice command to the device by producing one or more mouth click sounds immediately before and immediately after the voice command.

In yet another implementation, a speech recognition module is provided. The speech recognition module is capable of converting a human speech input captured by an acoustic-to-electric sensor to text data (speech-to-text). While a human user is dictating text to the device, one or more mouth click sounds can be used to indicate various text elements within the dictated text. These text elements could include, for example, line break, new paragraph, paragraph break, bullet pointing, bold or italic formatting or highlighting. In such implementations, the selected text elements can be associated with the one or more mouth click sounds according to the user's preference, using a graphical user interface. For example, a user can set in the settings that one mouth click sound should mean a line break, two consecutive mouth click sounds should mean a paragraph break. This feature can be implemented in a wide range of devices, including desktop computers, laptop computers, tablets, smartphones and other portable devices, augmented reality devices, head or arm mounted devices.

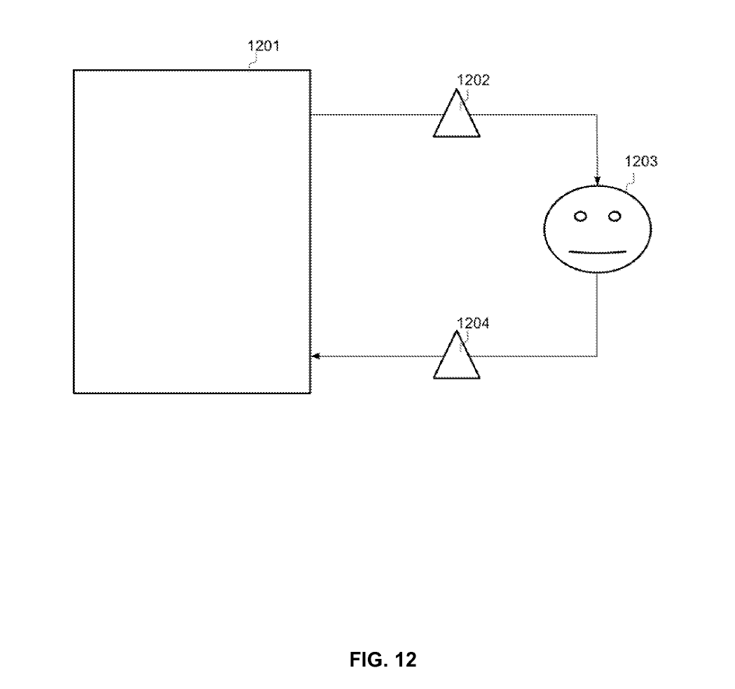

In various implementations, the one or more mouth click sounds can be interpreted as responses to a device's one or more prompts. Such implementation is visually explained in an exemplary drawing in FIG. 12. In such implementations, the device 1201 presents a visual, audio, or audiovisual prompt 1202 to the user 1203, to which the user responds with providing one or more mouth click sounds 1204. In Human-Device Interaction, prompts are provided, for example, to communicate closed-ended questions to the users. For example, a prompt could be: “Are you sure you want to delete the selected image?”. Such prompts are provided with one or more response options. For example, the prompt “Are you sure you want to delete the selected image?” could be provided with the following response options: “yes” and “no”. By producing one mouth click sound, the user can indicate a “yes” response to such prompts, while producing two consecutive mouth click sounds, the user could indicate “no”. Such implementations could have a pre-set interpretation of mouth click sounds, in which one mouth click sound is mapped to response options representing agreement, approval, confirmation, permission, validation, for example: “yes”, “next”, “accept”; while two consecutive mouth click sounds could be mapped to response options representing negation, disallowance, disagreement, denial, disclaim, for example: “no”, “none”, “cancel”, “stop”. Similar implementations could have the opposite logic, in which two consecutive mouth click sounds are mapped to response options representing agreement, approval, confirmation, permission, validation, for example: “yes”, “next”, “accept”; while one mouth click click sound could be mapped to response options representing negation, disallowance, disagreement, denial, disclaim, for example: “no”, “none”, “cancel”, “stop”.

The displays or display units mentioned in this document can be any hardware features that aim to provide visual representation of data to a user. More specifically, displays or display units can include, but not be limited to: screens, monitors, projectors, 3D displays, volumetric displays, OLED displays, laser video displays, screenless displays such as virtual retinal displays and bionic contact lenses, phased-array optics, holographic displays, ultra high definition displays and surface-conduction electron-emitter displays. Furthermore, the display or display units can be part of a larger hardware device, or the display or display units could form a separate hardware part of a larger device.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In some embodiments, the subject matter can be performed on portable devices, or a set of multiple, connected devices. Such devices include, but are not limited to head, eye or body mounted portable devices having a display interface and one or more sensors. Yet other implementations can include devices operating in such a way that one user or multiple users can access the device and give input to the device simultaneously. In certain implementations, functional parts of the device or device set can be physically separated. For example, one or more sensoric units can be physically separated from other functional units. The communication between such parts can be performed by wired and or wireless ways.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect”, “embodiment” or “implementation” does not imply that the aspect, embodiment or implementation is essential to the subject technology or that the aspect, embodiment or implementation applies to all configurations of the subject technology. A disclosure relating to an aspect, embodiment or implementation may apply to all configurations, or one or more configurations. A phrase, for example, an “aspect”, “embodiment” or “implementation” may refer to one or more aspects, embodiments or implementations and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A method for human-device interaction, comprising:
at least one device, the device comprising:
at least one central processing unit;
at least one memory;
at least one display;
at least one acoustic-to-electric sensor;
the said acoustic-to-electric sensor(s) receiving mouth click sound signals;
the said mouth click sound produced by human user by quickly moving the tongue from the palate to the floor of the mouth;
the said device processing the said signals.

2. A method for human-device interaction, comprising:
at least one device, the device comprising:
at least one central processing unit;
at least one memory;
at least one display;
at least one acoustic-to-electric sensor;
the said acoustic-to-electric sensor(s) receiving mouth click sound signals;
the said mouth click sound produced by human user by forming vacuum between the tongue and the palate, then quickly releasing the vacuum from between the tongue and the palate;
the said device processing the said signals.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. The method of claim 1, further comprising:
the device prompting the user for user input signals;
the user providing said mouth click signals as a response to the device's prompt for user input signals.

16. The method of claim 1, wherein the said mouth click signal is accompanied by one or more other user interaction signals.

17. The method of claim 1 further comprising a natural language and mouth click sound training module.

18. The method of claim 2, further comprising:
the device prompting the user for user input signals;
the user providing said mouth click signals as a response to the device's prompt for user input signals.

19. The method of claim 2, wherein the said mouth click signal is accompanied by one or more other user interaction signals.

20. The method of claim 2, further comprising a natural language and mouth click sound training module.

21. A computer readable medium comprising computer executable instructions adapted to perform the method of claim 1.

22. A computer readable medium comprising computer executable instructions adapted to perform the method of claim 2.

23. A computer readable medium comprising computer executable instructions adapted to perform the method of claim 3.

24. A computer readable medium comprising computer executable instructions adapted to perform the method of claim 4.

25. A computer readable medium comprising computer executable instructions adapted to perform the method of claim 6.

26. A computer readable medium comprising computer executable instructions adapted to perform the method of claim 7.

27. A hardware device with functions adapted to perform the method of claim 1.

28. A hardware device with functions adapted to perform the method of claim 2.

29. A hardware device with functions adapted to perform the method of claim 3.

30. A hardware device with functions adapted to perform the method of claim 4.

31. A hardware device with functions adapted to perform the method of claim 6.

32. A hardware device with functions adapted to perform the method of claim 7.
